(19) United States
(12) Patent Application Publication
(10) Pub. No.: US 2025/0274289 A1
(43) Pub. Date: Aug. 28, 2025

(54) PROTOCOLS FOR PROTECTING DIGITAL FILES

(71) Applicants: The Arizona Board of Regents on behalf of Northern Arizona University, Flagstaff, AZ (US); Brown University, Providence, RI (US)

(72) Inventors: Bertrand F. CAMBOU, Flagstaff, AZ (US); Maurice HERLIHY, Providence, RI (US); Roberto TAMASSIA, Providence, RI (US); Kimani TOUSSAINT, Providence, RI (US); Krishangi KRISHNA, Providence, RI (US)

(21) Appl. No.: 19/064,331

(22) Filed: Feb. 26, 2025

Related U.S. Application Data
(60) Provisional application No. 63/558,043, filed on Feb. 26, 2024.

(51) Int. Cl. H04L 9/32

(52) U.S. Cl. CPC H04L 9/3239

(57) ABSTRACT

A method and arrangement for converting a digital file into a cryptographic challenge-response-pair mechanism is disclosed. An encrypted digital file is concatenated with a random nonce and subject to one-way cryptographic functions and/or extended output functions such that a result C* is obtained having a known bit length. This result is organized into a series of addressable segments. A random seed is generated and is used to derive a random bit stream that is parsed into segments, each of which is read as an address in C*. These segments are applied as challenges to C*, and the corresponding responses may be used as or to generate or store an encryption key.

### CROSS-REFERENCE TO RELATED APPLICATIONS

The present application claims priority to U.S. Provisional Application 63/558,043 entitled “PROTOCOLS FOR PROTECTING DIGITAL FILES,” filed Feb. 26, 2024, the entirety of which is incorporated herein by reference.

### STATEMENT REGARDING FEDERALLY-SPONSORED RESEARCH

Not Applicable.

### BACKGROUND

Determining the authenticity or establishing trust with a digital file, a communication or an entity over distributed computing networks remains an ongoing challenge. Blockchain and other secure digital signature methods represent progress in this area. In particular, conventional blockchain and other distributed-ledger-based cryptographic systems can secure ledgers against alteration by appending a hash of the previous state of the ledger to each new transaction block. The ledger history and transactions are made resistant to alteration by use of cryptographic signing techniques. The hash of the previous ledger state is encrypted by a device originating a new transaction block using a private key associated with that device. The encrypted hash is included in the new transaction block as a digital signature which may be read by decrypting it using a public key corresponding to the private key included in the transaction block or otherwise made publicly available to other devices. If the decrypted signature matches the unencrypted hash of the previous ledger state, it can be assumed that the new transaction block is valid and has not been altered by another party.

Thus, blockchain technology is important because it offers protections in distributed networks, such as the non-alterability, and traceability of chains of transactions. Digital signature schemes are usually associated with blockchains to link a set of transactions with a set of clients and their public keys. This requirement, however, results in a disadvantage of conventional blockchain-based authentication schemes. Validating authenticity with these techniques is potentially complex, slow and requires considerable computing resources. Additionally, it is not always easy to verify the legitimacy of a client, and private keys can be stolen.

Numerous improvements to conventional authentication and encryption schemes have been suggested, which reduce or eliminate the necessity to securely store cryptographic keys. Many of these improved techniques rely on the use of addressable arrays of physical unclonable functions (PUFs) as cryptographic primitives for key generation and authentication. For example, U.S. Pat. No. 11,271,759, entitled “Secure Digital Signatures using PUF devices with reduced error rates”, published on Mar. 8, 2022, describes cryptographic key generation and authentication schemes using a processor, a physical-unclonable-function (“PUF”) array of PUF devices, an asymmetric public key generator (APKG), and memory coupled to the processor. U.S. Pat. No. 11,533,300, entitled “Encryption schemes with addressable elements”, published on Dec. 20, 2022, describes the use of physically unclonable functions (PUFs) for cryptographic and authentication purposes. Specifically, the disclosure describes implementations of systems using PUFs that may replace existing public key infrastructures (PKIs). The disclosures of both of the aforementioned publications are incorporated by reference herein in their entireties for all purposes. Generally speaking, these disclosures discuss the use of PUFs, and in some cases, images or copies of the PUFs, as challenge-response-pair (CRP) generation mechanisms for cryptography. PUFs have certain key advantages making them well suited for use as cryptographic primitives. Namely, PUFs may be thought of as one-way functions sharing properties with hash functions, with an expectation that the PUFs are unclonable, and unique.

Rather than storing keys, or even seeds for keys directly, devices in untrusted environments can generate keys using shared information by generating challenges to apply to the PUFs (e.g., the addresses of measurable PUF elements and/or measurement conditions). While this solves the problem of secure key storage, it requires that at least one device have physical access to the PUF, which may not always be desirable or possible. These methods also require ancillary systems such as associated hardware for PUF measurement, which again, may be disadvantageous.

CRPs based on digital files have also been proposed. For example, CRP mechanisms and challenge response assisted access authorization (CRA) schemes have also been applied to protect centralized or distributed network. An example of implementation is to form a look up table with indexes in the left column, and passwords in the right column. The challenges are pointing at an index to be paired with an associated password. These methods avoid the problem to have to deal with passwords that are changed periodically. These conventional CRAs have one incoming data stream, the challenge, driving one outcoming data stream, the response. For this reason, they are vulnerable to interception of the single incoming data stream.

Further improvement in the area of secure storage and authentication of digital files is warranted.

### BRIEF SUMMARY

Aspects of this disclosure are directed to converting a digital file into a CRP mechanism, which may be used for the generation of cryptographic components such as public or private encryption keys and verification of the authenticity of the file. In the embodiments to be described, PUFs as CRP mechanisms are replaced by a generic digital file to design a CRP mechanism.

In one embodiment, a file F is encrypted to generate a ciphertext C. Ciphertext C is converted to a digital bitstream of known length C* after concatenation with a nonce ω. The length of C* may be d=2\hat{ }D, where D is a number of digits (for example, d may be 1024, which requires that D=10). The resulting d bits are located at addresses varying from 1 to d. In one aspect, a fixed length of C* may be achieved by hashing and extending C with an extended output function (XoF). The combination of SHA-3 and SHAKE is usable for this purpose and compliant with current NIST standards. A one-time pad, as described below, is also secure.

In one embodiment, a challenge is generated, where the challenge has the form as the digital information needed to point at a particular position in the d-bit long stream C*. Challenges may be generated by generating a stream of S* bits by hashing and extending with a XoF a randomly selected seed S. The stream S* is segmented (sequentially or non-sequentially) into N challenges (q1, . . . , qi, . . . qN), each of which is D bits long. The D bits of each of the challenges qi re converted into a number xxi, with xxi The D bits of each challenges qi are converted into a number xxi, with xxi∈{1,d=2D}, which is turned into an address in C*. From each address xxi, P-bit long responses are generated from the content of C*. In total, the N challenges are pointing at N addresses in C* to generate N times P-bit long responses. In this manner, a digital file F may be converted into and use as a cryptographic CRP generator, which may be used for file authentication and in other cryptographic as described more fully below.

In another embodiment, the key generation methods just described are extended to implement method of protecting digital files, such as medical files, in a distributed computing environment with multiple control points. In these arrangements, confidential files are stored in a distributed, networked environment (e.g., stored in the cloud). Each file has an abstract description of the content of the file. During an enrollment cycle, two complementary subkeys are generated directly from each digital file with a challenge-response-pair mechanism (CRP), one from the responses (the subkey Kr), and one from the challenges (the subkey Kc). Both the file and the abstract are encrypted concurrently as part of the CRP processing. As done with blockchain technology, the file is subjected to one-way functions (e.g., a hashing function) to ensure that a single bit change in the file totally changes the resulting data streams of the CRP mechanism. During a verification cycle, the subkey Kc from the challenges can decrypt the abstract; however, both subkeys are needed to decrypt the file, which can be distributed to several parties. The subkey Kr from the responses can also be cut into separate segments, thereby enabling multiple points of control of the files.

The use of digital files as CRP mechanisms as summarized above has certain advantages. The challenge-response-pair (CRP) mechanisms described in this disclosure enable parties operating in a distributed network to rapidly verify the authenticity of digital files with relatively low computing load. An example practical use case is when a client wishes to provide proof of authenticity of an older financial transaction. According to the methods and arrangements disclosed here, the file can be manipulated to yield a CRP mechanism that has the same key advantages of PUFs, i.e., that have a high degree of uniqueness. This uniqueness is achieved by concatenating the files with randomly picked nonces. Most files are cloneable, therefore the nonces may be only used once, and may be erased after verification cycle. During an enrollment process, the input data, the “challenges”, generates with CRP mechanisms the output data, the “responses”, which can encrypt a proof of authenticity. After enrollment, the client can keep secret the nonce, erase the responses, and release the file, the challenges, and the encrypted proof of authenticity. The latter is recovered during a subsequent verification cycle when the client elects to disclose the nonce.

Additional advantages and features will be apparent upon review of the following detailed description.

### BRIEF DESCRIPTION OF THE DRAWINGS

The drawings described herein constitute part of this specification and includes example embodiments of the present invention which may be embodied in various forms. It is to be understood that in some instances, various aspects of the invention may be shown exaggerated or enlarged to facilitate an understanding of the invention. Therefore, drawings may not be to scale.

FIG. 1 schematically illustrates process flow through a computing system by which a digital file may be converted to act as a challenge-response-pair mechanism.

FIG. 2 schematically illustrates an alternative process flow through a computing system by which a digital file may be converted to act as a challenge-response-pair mechanism, in which a subset of responses is selected.

FIG. 3 illustrates an arrangement for enrolling a document to generate an encrypted an encrypted authenticity certificate.

FIG. 4 illustrates an arrangement for authentication of a document in a distributed environment.

FIG. 5 is a chart illustrating various use cases for distribution of information needed to decrypt a file among various parties, according to one embodiment.

FIG. 6 is a chart illustrating bitstreams usable as CRP mechanisms according to an alternative embodiment for converting a file into a CRP mechanism.

FIG. 7 schematically illustrates a process flow through a distributed computing environment for securely storing and authenticating a patient medical record and an abstract.

FIG. 8 schematically illustrates a process flow through a distributed computing environment for an enrollment process for an encrypted abstract and distribution of information to recover decryption keys.

FIG. 9 schematically illustrates a process flow through a distributed computing environment for authenticating a patient medical record and decrypting an abstract that has been enrolled according to the process of FIG. 8.

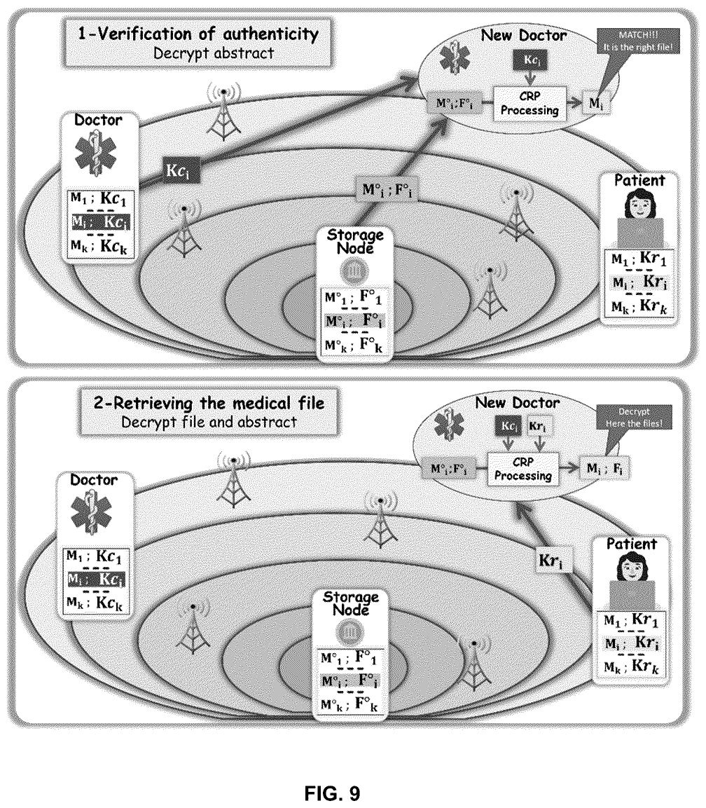

### DETAILED DESCRIPTION

The described features, advantages, and characteristics may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments.

Reference throughout this specification to “one embodiment,” “an embodiment,” or similar language means that a particular feature, structure, or characteristic described in connection with the embodiment is included in at least one embodiment. Thus, appearances of the phrase “in one embodiment,” “in an embodiment,” and similar language throughout this specification may, but do not necessarily, all refer to the same embodiment. References to “users” refer generally to individuals accessing a particular computing device or resource, to an external computing device accessing a particular computing device or resource, or to various processes executing in any combination of hardware, software, or firmware that access a particular computing device or resource. Similarly, references to a “server” and a “client” refer generally to a computing device acting as a server, or processes executing in any combination of hardware, software, or firmware that access control access to a particular computing device or resource.

Embodiments of the invention are directed to systems and methods for manipulating digital files to generate CRP mechanisms, then using those CRP mechanisms in various practical cryptographic applications. The methods described herein may be implemented in various computing environments, e.g., with multiple users or in client-server relationships. Each computing device in the computing environment being used by a user (e.g., a client or server) may have various features. For example, a computing device may one or more programmable processors. These processors may be quantum or non-quantum processors. They may be native binary or native non-binary (e.g., ternary) processors. Computing may also have one or more input/output devices that are typically found with computing devices such as keyboards, mice, touch screens, stylus pads, cameras, microphones, speakers and monitors or other visual displays. Computing devices may also have volatile memory (e.g., RAM), in electronic communication with their respective processors. Computing devices may also have non-volatile storage (e.g., SSD drives, disk drives, flash storage, etc.) in electronic communication with their respective processors. Non-volatile storage may store computer code embodying computer executable instructions capable of being executed by the processors to carry out the various method steps discussed herein, including the method steps described below. Non-volatile storage may also store digital files, ciphertext generated from digital files, and other data elements described herein. Computing devices may also include communication interfaces (e.g., network interface cards), which are data transceivers supporting communications via a data network (e.g., a LAN, WAN or the internet) with other computing devices. The data networks may be a wired or wireless data communication network and interfaces may be wired or wireless interfaces, or may include both wired and wireless interface components. Computing devices may also include random number generators, or pseudo-random number generators, as ASICs or preferably as software processes running on the device processors.

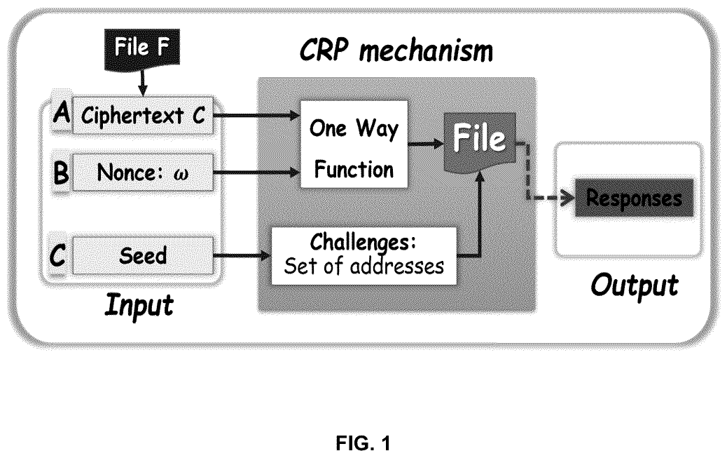

FIG. 1 shows a schematic arrangement for deriving a CRP mechanism for a digital file F, which preferably is stored in non-volatile data storage as described above. The method illustrated in FIG. 1 is preferably executed by one or more programmable processors in one or computing devices, where the one or more processors execute computer readable program code stored in non-volatile storage, which embodies computer-executable instructions.

Referring now to FIG. 1, a file F is received. The file is encrypted with a secret encryption key Sk, that may be generated according to any public-private key asymmetrical encryption algorithm (e.g., DSA, RSA, ECC, Diffie-Hellman, etc.). The result of encrypting file F is a ciphertext C. A nonce ω is generated, preferably with a random number generator or PRNG. C and nonce ω are concatenated and the resulting bitstream is subject to a one-way function process that generates a fixed bit length output. For example, C and the nonce may be concatenated, then hashed, then provided to an extended output function (XoF). For example, the concatenation of the nonce and C can be provided to a NIST-compliant hash function (e.g., SHA-3, SHA-1, SHA-2, or ASCON.) and the result fed to SHAKE (e.g., SHAKE-128 or SHAKE-256) to generate an output bitstream of a predetermined bit length. This output bitstream will be denoted as C*, and will have a bit length of d bits, where d=2\hat{ }D. C* may then be segmented into d, addressable segments.

The same bitstream C* is used to generate a series of N challenges. This may done by generating a random seed number S, again preferably with a RNG or PRNG, but this process may be supplemented with other data like time, location, user supplied passwords, etc. Seed S is again subject to a one-way process that results in a fixed bit length output (e.g., hashing with a hash algorithm and then subjecting the resulting hash to an XoF, as described above for the generation of C*). The result is S*, and the XoF resulting in S* is chosen such that S* has a bit length of N×D. S* is then segmented into N, D-bit long segments, each of which encodes an address (i.e., a bit position) in C*. C* may be challenged by reading a challenge, looking at the position in C* indicated by the challenge, and reading the response. Each response will be P bits long. For example, each response will be the bit located at position XXi, and then the next P-1 bits calculated according to the method set forth in (5) below.
(1) Let C=encrypted file F with key Sk
(2) From C and nonce ω generate C*, a file of constant length d, with d=2^{D}
(3) Organize C* with bits located at addresses 1 to d.
(4) Generate N challenges from C*.
   Pick random seed S
   Hash and extend S to form S* a N×D long stream of bits
   Segment S* into D-bit long challenges {q₁, . . . ,qᵢ, . . . ,q_{N}}; i∈{1, N}.
   From {q₁, . . . ,qᵢ, . . . ,q_{N}} point at the positions {xx₁, . . . ,xxᵢ, . . . ,xx_{N}} in C*; xxᵢ∈{1, d=2^{D}}
(5) From positions {xx₁, . . . ,xxᵢ, . . . ,xx_{N}} generate N responses {r₁, . . . ,rᵢ, . . . ,r_{N}}.
   Let {xx_{(i,1)}, . . . ,xx_{(i,j)}, . . . ,xx_{(i,P)}} be the P positions computed from any of the xxᵢ with:
      j∈{1, P}; α and β are prime numbers
      If j=1: xx_{(i,1)}=xxᵢ
      If j∈{2, P}: x_{(i,j)}=α xx_{(i,j-1)}+β mod (2^{D}).
   Read in C* the P bits at position {xx_{(i,1)}, . . . ,xx_{(i,j)}, . . . ,xx_{(i,P)}} to generate stream rᵢ
   Generate the resulting stream of responses consisting of N×P bits.

The probability to get twice to the same position during step (5) is non-negligeable, but this is acceptable for certain protocols. One of the remedies is to add an index to modify the responses during recurrent challenges. For example, during the second pass, the ββ can be replaced by ββ+1 which is enough to generate a distinct response; the ββ is replaced by ββ+2, during the third pass, et cetera.

Note that the algorithm for generating responses disclosed above is exemplary only. Other ways of generating responses are possible. For example, a challenge, qi may be used as a seed to some one-way function, which may then produce an output of other locations within C* from which to assemble the bits of the response. Other variations are possible, the significant requirement be that the challenge is parsed or used in some way to identify bits in C* that will be the responses.

The response bitstream may be used as an encryption key to encrypt a file M attesting to the authenticity of F and or C, according to any encryption algorithm described in this disclosure. Alternatively, the response bitstream may be used as an input to a keying algorithm, for example, a keying algorithm used by any of the encryption algorithms disclosed in this disclosure. Alternatively, as is described more fully below, a key K may be randomly generated, and then the response bitstream may sub-selected to retain values at positions that correspond to a first digital symbol (e.g., a “1”) in K. K may then be used for encryption, and then deleted. The sub-selected response bitstream may be retained. In the future, to recover K, another full response bitstream is generated and is compared to the retained, sub-selected response bitstream. Matching positions in the full response bitstream correspond to “1” is K, and the remaining positions correspond to “0s”. In this manner, K can be recovered.

The CRP mechanism generation method described above and illustrated in FIG. 1 is highly secure because three totally independent streams are required in order to uncover the responses: C, ω, and S. The responses cannot be generated if any of these inputs are missing, thus, keeping secret just one of the three provides enough security. The computing power needed to run the CRP mechanism is extremely low. In the example of the 256-bit long responses, the 256 bits randomly located in file C* can be quickly retrieved. For example, if N=16 and P=16, the CRP mechanism generates responses containing 256 bits. When d=1024, D=10, a 16×10=160-bit long random seed is needed.

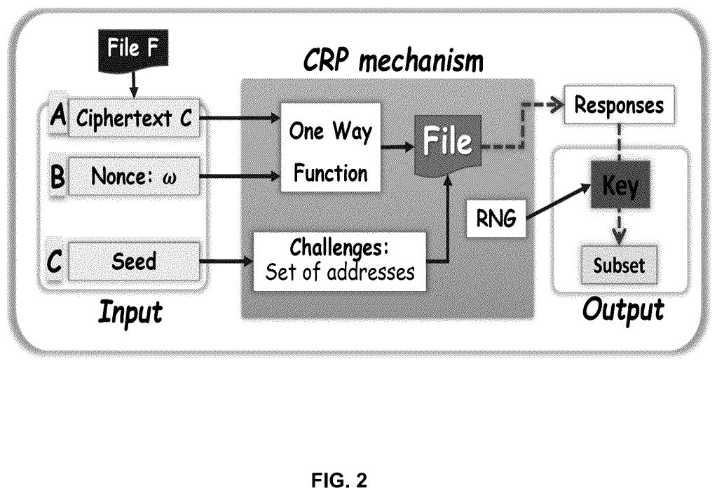

The security of the technique set forth above may be expanded by using a subset of responses. After generating N responses having P bits each, an ephemeral key K may be picked randomly with a random number generator (RNG). Only the positions in the response bitstream corresponding to positions in K with a state of “1” (or generally, a first binary symbol) are retained, and these responses are used to later rebuild K by placing 1s (or the first binary symbol) at the positions of matching responses, and then 0s elsewhere. This technique for key recovery is described in detail in U.S. Patent Publication No. U.S. Pat. No. 20,250,023736A1 entitled “Protocols with noisy response-based cryptographic subkeys” (published on Jan. 16, 2025), and that reference is incorporated herein by reference in its entirety for all purposes. Implementation of this technique for key generation results in retaining a response subset averaging N/2 responses. The resulting subset of the sequence of responses is kept for future operation, and the key can be used to encrypt various files, and messages verifying authenticity. FIG. 2 shows a block diagram summarizing this scheme.

Such a CRP mechanism is more secure than the one presented above because four totally independent streams are requested to uncover the responses, which are C, ω, S, and the subset of responses (derivable from K). The computing power needed to run the CRP mechanism could be higher than the simpler protocol, but remains low. For example, about 128 responses that are 32-bit long are generated when K is 256-bit long. Therefore, 4 Kbytes randomly located in file C* are retrieved, rather than 256 bits in the simpler protocol. This protocol eliminates the concatenation cycle of K as done in section 1.1, which accelerates the CRP process.

Various extensions and practical applications using the CRP generation mechanisms described above will now be disclosed.

A first example of use case is to validate the authenticity of ciphertext C in a distributed network (i.e., a network having two or more networked computing devices). C could be am encrypted contract describing a financial transaction with crypto-currencies. A client device should have the ability to involve an Agent to validate the authenticity of the contract as needed. Two protocols are presented below: a first protocol based on the CRP mechanism originally described (i.e., in FIG. 1) and a second protocol based on using K to select a response subset (i.e., in FIG. 2).

### Using the Responses as Ephemeral Keys

For this computer implemented method, a CRP mechanism is used such as the one described above and illustrated in reference to FIG. 1. The method starts with an enrollment process, during which Ciphertext C is used, nonce ω is chosen, and a randomly picked seed S is chosen to generate the responses. The responses are concatenated to generate an ephemeral encryption key K, which is used to encrypt an authenticating message M. During verification, the same CRP mechanism retrieve the key K to decrypt M from C, ω and S. In this simplified example d (length in bits of C*)=1024=210, D (length in bits of each address in C*)=10, N (number of challenges and responses)=32, P (bit length of each response)=8. The protocol is summarized as follow:

### Initial Set Up—Enrollment

The initial set up can be initiated by a client computing device, with the objective of putting in place the mechanism protecting an authenticating message M with an ephemeral key K. The key K is generated according to the following algorithm, in which the Client computing device has access to an encrypted digital file C, and may generate two other random numbers (e.g., with an RNG or PRNG), the nonce and the seed S.
(1) Generate C* from ciphertext C and nonce ω
(2) Organize the d-bit long file C* with bits located at addresses 1 to 1024.
(3) Generate 32 challenges from C*
   Pick random 320-bit long seed S
   Segment S into 32 challenges {q₁, . . . ,qᵢ, . . . ,q₃₂} that are 10-bit long each; i∈{1, 32}.
   From {q₁, . . . ,qᵢ, . . . ,q₃₂} point at the positions {xx₁, . . . ,xxᵢ, . . . ,xx₃₂} in C*; xxᵢ∈{1, 1024}
(4) From positions {xx₁, . . . ,xxᵢ, . . . ,xx₃₂} generate N responses {r₁, . . . ,rᵢ, . . . ,r₃₂}.
   Let {xx_{(i,1)}, . . . ,xx_{(i,j)}, . . . ,xx_{(i,8)}} be the 8 positions computed from any of the xxᵢ with:
      j∈{1, 8}; α and β are prime numbers
      If j∈1: xx_{(i,1)}=xxᵢ
      If j∈{2, 8}: x_{(i,j)}=α xx_{(i,j-1)}+β mod (1024).
   Read in C** the 8 bits at position {xx_{(i,1)}, . . . ,xx_{(i,j)}, . . . ,xx_{(1,8)}} to generate stream rᵢ Remark: The resulting stream of responses consists of 32×8=256 bits
(5) The responses are concatenated into an ephemeral 256-bit long key K.
(6) Let M*=encrypted M with key K and symmetric encryption scheme
(7) Memorize nonce ω, and File F
(8) Distribute C, the seed S, and M*

After completion of the initial set up, the client preferably erases the responses, and the ephemeral key, which can only be recovered with a CRP mechanism from the file C, nonce w and seed S With d=1024, and N=32 the number of possible CRPs is 4.6×10\hat{ }60; the entropy is 200.

### Verification of the Authenticity of C

Third parties seeking to verify the authenticity of C by recovering M need to get access to nonce ωthe seed S, and M*. This may be done in a distributed system where the file C, the seed and cipher text of M are provided at a single storage node, while the client provides nonce ω to the party seeking to verify C. The verification protocol is the summarized as follow:
(1) Recover C* from C and nonce ω
(2) Form 32 challenges from seed S
(3) From the challenges, and C* generate 32 responses that are 8-bit long each
(4) The responses are concatenated into an ephemeral 256-bit long key K.
(5) Let M=decrypted M* with key K and symmetric encryption scheme

The computing power needed for verification is light. The CRP mechanism only requires the computing power to read 256 bits in file C*. The concatenation, and symmetrical encryption can be done with light methods that can be implanted in encryption specific hardware (e.g., asics). As discussed below, variations of the protocol can make the file C or the seed S secret instead of nonce ω.

### Randomly Selected Ephemeral Key Generating a Subset of Responses

The protocol now described uses the method described above in regard to FIG. 2, which uses a randomly selected subset of responses, such that the final ephemeral key is generated using a random number. This results in the generation of a subset of the sequence of responses. The levels of security are higher. In this simplified example d=1024, D=10, N=256, P=32. The protocol is summarized as follows:

### Initial Set Up/Enrollment

An initial set up is again initiated by a client with the objective of protecting an authenticating message M with an ephemeral key K. The enrollment procedure is as follows:
The initial set up is again initiated by the client with the objective of protecting an authenticating message M with an ephemeral key K.
(1) Generate C* from ciphertext C and nonce ω
(2) To organize the d-bit long file C* with bits located at addresses 1 to 1024.
(3) Generate 256 challenges from C*
   Pick random seed S
   Hash and extend S to form S* a 256×10 long stream of bits
   Segment S* into 10-bit long challenges {q₁, . . . ,qᵢ, . . . , q₂₅₆}; i∈{1, 256}.
   From {q₁, . . . ,qᵢ, . . . ,q₂₅₆} point at the positions {xx₁, . . . ,xxᵢ, . . . ,xx₂₅₆} in C*; xxᵢ∈{1, 1024}
(4) From positions {xx₁, . . . ,xxᵢ, . . . ,xx₂₅₆} generate 256 responses {r₁, . . . ,rᵢ, . . . ,r₂₅₆}
   Let {xx_{(i,1)}, . . . ,xx_{(i,j)}, . . . ,xx_{(1,32)}} be the 32 positions computed from xxᵢ with:
      j∈{1, 32}; α and β are prime numbers
      If j=1: xx_{(i,1)}=xxᵢ
      If j∈{2, 32}: x_{(i,j)}=α xx_{(i,j-1)}+β mod (1024)
   Read in C** the 32 bits at position {xx_{(i,1)}, . . . ,xx_{(i,j)}, . . . ,xx_{(1,32)}} to generate stream rᵢ
(5) Pick randomly the ephemeral 256-bit long key K.
(6) Keep the responses located at positions of K with a state of “1”
(7) Delete the responses located at positions of K with a state of “0” Remark: this results in a subset of sequence averaging 128 responses.
(8) Randomly inject up to 25% bad bits in the subset of responses.
(9) Let M*=encrypted M with key K and symmetric encryption scheme
(10) Memorize and keep secret nonce ω, and File F
1(11) Distribute C, the seed S, the subset of responses, and M*

It will be noted that the probability to get twice to the same challenge during step (4), is non-negligeable, which potentially disadvantageous as it reduces entropy. One of the remedies is to add an index to modify the responses during recurrent challenges, as described above.

After completion of the initial set up, the client preferably erases the responses that are not part of the subset, and the ephemeral key K, which can only be recovered from C, nonce w and seed S. For example, if d=1024 bit, the number of possible CRPs is 3.4×10\hat{ }248; the entropy is greater than 256.

### Verification of the Authenticity of C

A party wishing to verify the authenticity of C needs to recover (i.e., decrypt) M. To do so, that party must obtain access to C, ω, S, the subset of responses, and M*. In a distributed system, C, S, M*, and the subset of responses can be provided by a storage node, while the client may provide nonce ω. The verification protocol is the summarized as follows:
1. Recover C* from C and nonce ω
2. Form 256 challenges from seed S
3. From the challenges and C* generate 256 responses that are 32-bit long each
4. Recover K by comparing the 256 responses with the subset of responses.
5. Let M=decrypted M* with key K and symmetric encryption scheme

A criteria may be applied to judge a matching response (i.e., when a response in the subset of responses matches a response in the generated responses). One match criteria determines a match when at least 25% of the bits are matching, which is higher than the rate of bad bits added during noise injection

The computing power needed for such a verification is higher, but still light for a distributed network. Step (8) of the enrollment cycle is to be considered as an example of additional security. The injection of bad bits in the subset of response, a process that can also be called “noise injection”, has no effect in the outcome of the protocol, as long as the noise level is below the threshold that can disturb the recovery of K. However, having noisy responses can increase the one-wayness of the CRP mechanism, by obfuscating the cryptoanalysis after verification cycle. Without such a feature, the crypto-analyst can keep track of the challenge-response-pairs for future analysis. An alternate method is the one in which the subset of responses is controlled by the client. Intentional errors can be injected on purpose into the key K, by making the subset excessively noisy. In such a case the retrieval of K may require data helpers, and fuzzy extractors.

### Implementation in Distributed Networks

The schemes described above can protect important transactions taking place across distributed networks. An example of use case that can benefit from the additional protection is one where a client wants to offer mechanisms allowing independent parties to verify the authenticity of a transaction that is contained in file F. This file can be encrypted as ciphertext C, however the method described here works well when the file is not encrypted. In the arrangements that follow, the roles of the participating parties (each of which can be a computing device or a user of a computing device) are defined as following:
Client: owns file F but directs a Storage Agent to store C for some duration.
Agent: Represents the Client
Storage Agent: works at the direction of the Client or the Agent to store information for a fixed term. The data is public.
Smart Contract: The client's rent is kept in escrow in the contract until the rental expires. The client issues periodic challenges to check that the storage agent is faithful. If a challenge fails, the smart contract refunds the rent to the client. Because smart contract state is always public, the contract cannot keep any secret data.

### Initial Setup/Enrollment

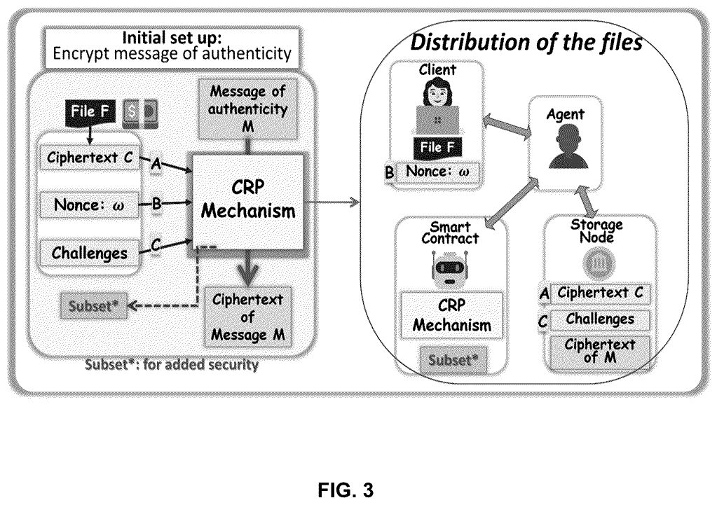

After completion of the transaction contained in F, the client uses a CRP mechanism during an initial set up phase, as shown in connection with FIG. 1 or 2, then distributes the information to the network. This can be completed with various methods, such as the one shown in FIG. 3. In most implementations, a compact seed replaces the challenges, as described above in reference to FIGS. 1 and 2.

A setup/enrollment and information distribution and storage protocol is as follows:

The client is either equipped with the software needed to operate a CRP mechanism or can employ a contract agent to perform the confidential task. The client generates a key K with the ciphertext C, Nonce ω, and a seed S. The message of authentication M is encrypted with K. The message of authentication could be something simple such as:

“Yes, I (client X) am confirming the authenticity of ciphertext C.”

Both methods described above in connection with FIG. 1 or 2 can be applied, in particular the method that uses a random number generator for the ephemeral key K and the generation of a subset of responses. The same protocol can be applied if the client wishes to protect un-encrypted file F instead of ciphertext C.

The client dispatches openly in the distributed network the resulting information, with the exception of File F, and nonce ω. An active participant such as an Agent can take care of the distribution of the information. In the example shown in FIG. 3, the distribution is the following:
The smart contract equipped with the technical capability to perform CRP mechanisms keeps the subset of responses, which is public information.
A storage node keeps track of the remaining publicly available information: ciphertext C, the challenge (or seed), and the cipher text of M.
Any other third party in the distributed network has the opportunity to participate.

After completion of the initial set up phase, the client keeps in a secure location File F, Ciphertext C, and Nonce ω along with the list of files needed for future transactions. Each client in the distributed network can thereby keep track of a set of important files, each describing important transactions.

### Verification of Authenticity

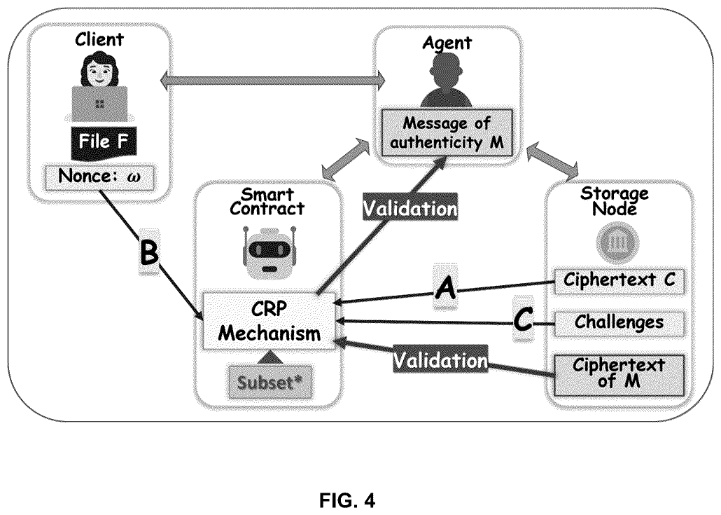

When the verification of the authenticity of ciphertext C (or file F) is needed, the client communicates Nonce ω to the agent. The Agent coordinates the effort between the Smart Contract, and the storage node, initiating a protocol shown in FIG. 4. The protocol is summarized as follows:
The Smart Contract, which is equipped with the CRP mechanism and with the subset of responses, collects Nonce ωω, Ciphertext C, the challenges, and the Ciphertext M* of the message of authenticity M.
The CRP mechanism has the information needed to decrypt M*, and deliver it to the Agent, and the distributed network. This verifies the authenticity of Ciphertext C.
The client has thereby the capability to interact privately with other selected clients to disclose privately the content of File F, allowing the de-ciphering of C. In such case, a separate arrangement is needed to share the cryptographic key. A very convenient method is the use of a PKI, and public/private key pairs.
When File F is directly used instead of ciphertext C, File F is openly authenticated.

The client has the possibility to iterate, create a new message of authenticity, a new nonce, new challenges, new subset, and this for further references.

### Collaborative Validation

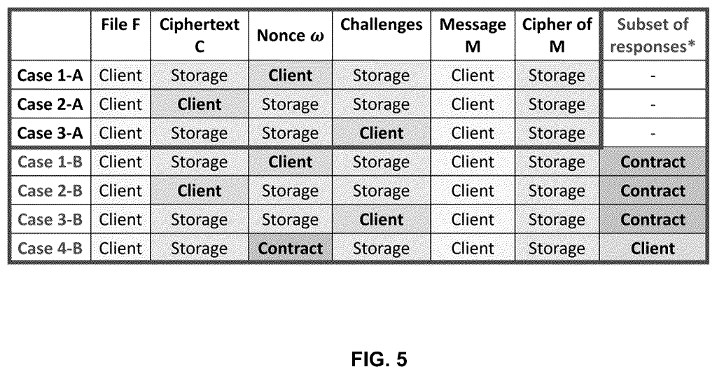

The methods to verify authenticity, as presented here are based on the handling of three or four independent elements: Ciphertext C, Nonce ω, the challenges, and the subset of responses. These pieces of information may be distributed in any manner among various parties and computing devices, depending on the application and its requirements. For example, a Client device can hold any of these streams, and distribute openly the other two or three elements. Various ways in which data elements may be distributed are shown in the chart of FIG. 5, which classifies various use cases by which entities are holding what pieces of information.

The various use case scenarios depicted in FIG. 5 have various advantages and disadvantages. The respective value of each case can be summarized as follows:
Case 1A or 1B: The Client only keeps Nonce ω in addition of File F, and Message M. Such a method is valuable because the entire chain of information is obfuscated. The stream of length S is kept secret, as well as the set of responses from the CRP mechanism. The Ciphertext C or File F are public information, which enhances the transparency of the protocol.
Case 2A or 2B: The client keeps file F, Ciphertext C, and Message M. The level of obfuscation is also high. Again, the stream of length S is kept secret, as well as the set of responses from the CRP mechanism. The perception from a collaborative network could be negative, as there is no trace of File F, and Ciphertext C in the distributed network. Such an approach is interesting to dispatch information as needed, while offering proof of authenticity upfront.
Case 3A or Case 3B: The Client keeps the challenges in addition of File F, and Message M. This case is similar to case 1, offering high transparency in the protocol. However, the stream of length S becomes public information as the knowledge of both Nonce ωω, and Ciphertext C, are public information. The protocol is still secure, without the challenges, it is not possible to recover M.
Case 4B: The Client keeps the subset of responses in addition to File F, and Message M. This case is similar to cases 1 and 3, offering high transparency in the protocol. However, the stream of length S becomes public information as the knowledge of both Nonce ω, and Ciphertext C, are public information. The stream of responses is also public information. The protocol is still secure, without the subset of responses, it is not possible to recover M.

An interesting variation is the combination of Cases 1B and 4B in which the Client keeps both Nonce ω, and the subset of responses. Security is enhanced, while the transparency behind File For Ciphertext C is maintained.

Any suitable encryption algorithm may be used for any encryption/decryption steps disclosed in this disclosure (e.g., to generate ciphertext C, or M*, or to decrypt M*). By way of example only, AES, DES, ASCON, Elliptic curve, RSA, Crystals Dilithium, Crystal Dilithium, Falcon, SABER, NTRU, Classic McElice, SPHINCS, lattice cryptography, LWE, LWR, or hash-based cryptography may all be used for encryption/decryption as discussed herein.

Moreover, while this disclosure refers to the generation of a nonce or seed number using a RNG or a PRNG, the inventive embodiments are not so limited. Random number generation may be replaced or supplemented by other methods for number generation such as the use of one-time pads, passwords, date, time, pin code, authentication code, PUFs, and local conditions.

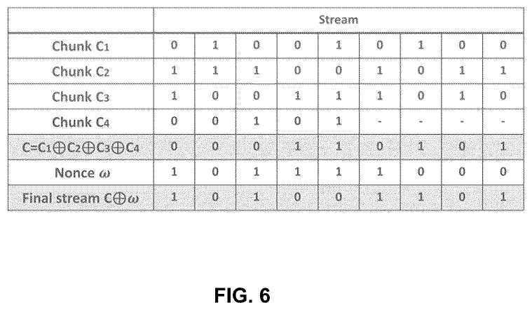

In the methods described above, an encrypted file C is provided as input to a hash function and an XoF to generate a bitstream of fixed length S. This method is highly secure, however for some applications, a lighter scheme could be acceptable. An example of such a lighter scheme is to segment the digital stream of File C into S-bit long chunks, and to XOR the chunks together. The resulting stream is then XORed with Nonce ω as shown in the small example of FIG. 6. The file in the example is 29 bit long, containing three 8-bit long files, and one 5-bit long file. The XORing of the four smaller files is generating an 8-bit long file. Such a simplified method is like a one-time pad, the knowledge of the final stream cannot disclose File C, it is perfectly secure. However, the knowledge of both the final stream, and Nonce ωω Nonce is vulnerable to certain frequency analysis, and brute force attacks.

The method described above converts file C with nonce ω into a file of fixed length C*. For some applications the security could be enhanced by converting each File C into d-bit long digital streams C* of variable length that is still verifying d=2D. Before concatenation with the nonce, the length d* of C is verifying 2D-1<d*≤2D.

[Ex: if d*=8192=213, d=d*, and D=13; if d*=8200, d=16,384, and D=14]

When d*≠2D, the file C is concatenated with nonce ω while keeping the length of the resulting data stream C* at d=2D. The challenge generation from the seed needs to know D. As described in section 1, the stream of bits generating N challenges is fragmented in N×D-bit long chunks of bits. For example, if N=16 and P=16, the CRP mechanism generates 256-bit long streams of responses. When d*=8200, D=14, a 16×14-224-bit long random seed is needed.

The concepts described above for converting a digital file into a CRP mechanism from which encryption keys may be generated may be extended to other practical applications. One such application, which is directed to secure storage of medical documents in a distributed environment with multi-party access will now be described.

The value of storing Electronic Health Record (EHR) and Electronic Medical Record (EMR) in the cloud, or open distributed network, is limited by privacy and confidentiality concerns. That is to say, the advantage of being able to freely share medical information is limited by legal concerns that mediate how documents must be stored and shared. Patients may wish to interact with groups of specialists, to get access to broader medical expertise, and second opinions. Storing information in the cloud is cheap and convenient, however in addition to the privacy issues, the massive amount of information stored online could be confusing. The conventional solution to satisfying privacy concerns is to encrypt sensitive medical information, however, when a file is encrypted, it is hard to verify that it is the right file, in particular for patients dealing with complex medical records.

One way to balance the need to easy access to information about patient records, while restricting access to the underlying sensitive information would be to combine an encrypted file with an abstract that is not encrypted. Such an approach raises two questions: how easy it is to verify that the abstract is paired with the right encrypted file, and how private this abstract should be? Using encryption in the cloud is also challenging due to the complexity of generating and storing the cryptographic keys. The solution to simply rely on the doctor to manage the keys may not be acceptable to all, in particular when multiple parties are involved such as nurses, medical assistants, and a group of doctors.

Inventive embodiments are directed to solutions to these problems. The embodiments described below achieve the following advantages and features:
Each file should be encrypted and stored in a storage node in an open distributed network.
A brief summary of each file should be available on demand.
Non-alterability: Even tiny modifications of the files should be noticeable.
Non-repudiation: The origin of the file should be indisputable.
Confidentiality: Each file should be encrypted with a one-time use key.
Multi-party control points: The deciphering of the file should involve at least two parties such as a doctor and a patient.
After recovery of each file, new keys should be generated, making the old keys useless.
The key generation and file recovery should be done within milli seconds with ultra-light computing power (keeping the cost of gas low).
The method is compatible with the integration of multi-factor-authentication (MFA).

While the example that follows is directed to the protection of medical, the protocols can be applied to the generic case of any files stored in an open distributed network.

### Description of the Generic Protocol with Multiple Control Points

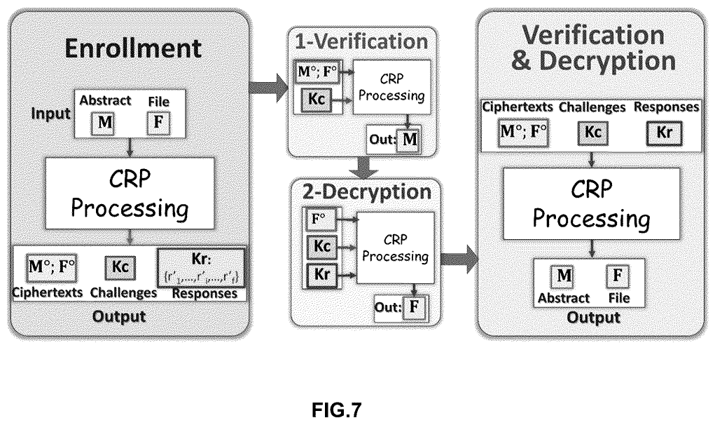

The protocol, which is summarized in FIG. 7, is handling a digital file F, and associated abstract M. The abstract can, for example, briefly describe the content of F, without the information that is judged confidential. The protocol has three cycles, enrollment, verification, and file retrieval through decryption:
During enrollment the files F and M are processed through a CRP mechanism to generate ciphertexts F° and M°. The first subkey Kc is generated from randomly picked challenges, and a second subkey Kr:{r′1, . . . ,r′f} from f responses that are computed with the CRP mechanism. Any changes in F totally modify the ciphertexts, and Kr.
During a verification cycle the abstract M is decrypted. The CRP processing is based on both the encrypted file F°, and subkey Kc. Therefore, a successful decryption of M only occurs by pairing M° and F°, which provides proof of authenticity of F.
During the retrieval of F through decryption both subkeys Kc and Kr are needed. This requires a collaboration between the parties keeping these subkeys. The f responses of Kc can be distributed to multiple control points to enhance security.

Variations of the protocol include the combination of both verification and decryption, as shown in the right side of FIG. 7. The protocol can also be simplified by eliminating the abstract, and verification cycle, as shown in the central bottom side of FIG. 7.

### Protection of Medical Files

The generic protocol described above in reference to FIG. 7 is here applied, as an example, to the protection of medical files archived in a storage node of a publicly distributed network. An abstract for each file is useful to avoid retrieving the wrong document.

### Enrollment of the Medical Files

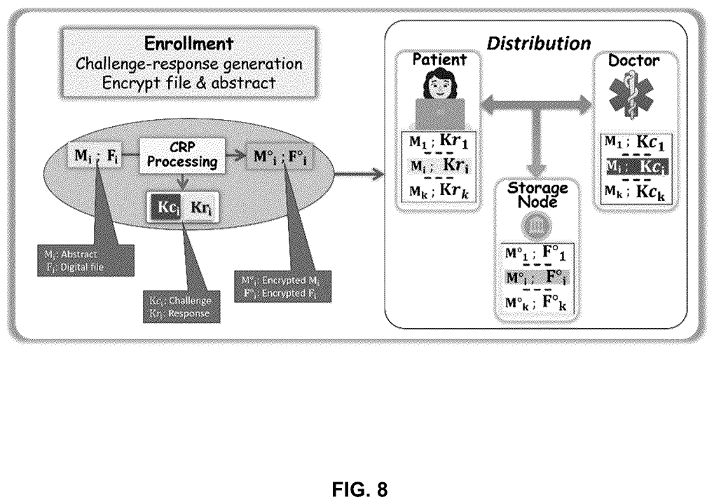

As shown in FIG. 8, during the enrollment cycle, a set of k medical files Fi with their respective abstracts Mi are going through the encryption process, each file being also used to generate their unique key pair Kci-Kri. For each file, a trusted custodian (e.g., a doctor) keeps the abstract Mi and the subkey Kci while the patient keeps the same abstract and the subkey Kri. The cipher text of the file F°i and the abstract M°i are archived in a publicly available storage node. The overall enrollment cycle, which is fast and does not require a lot of computing power, can be done by the trusted custodian, or a designate such as a smart agent. Both doctor and patient may have a small app downloaded onto their respective computing to organize and store the abstracts and corresponding subkeys, which have small sizes, typically less than 10 Kbytes.

### Transfer of the Medical Files

The protocol to transfer the file Fi to a new doctor has two steps: i) verifying that this is the right file, then ii) decryption of the ciphertext retrieved from the storage node, as shown in FIG. 8. The new doctor downloads in its computing environment the ciphertexts F°i and M°i from the storage node. The CRP processing can be an app that is available to the new doctor, or a service provided online by a smart contract.

To verify authenticity of Fi, the doctor transmits the subkey Kci to the new doctor. The CRP mechanism allows the deciphering of the abstract Mi after inputting the ciphertexts F°i and M°i. The new doctor can read openly Mi, confirming that it is what is needed. The deciphering of the file requires the second subkey Kri, which has to be provided by the patient. Every time a file has been decrypted, the ciphertexts F°i and M°i can be erased and replaced by new ciphertexts through a new enrollment cycle, and new pairs of subkeys can be generated. The subkey Kri can also be cut into smaller pieces and distributed to several control points to enhance security.

In the use case just described, the method is agnostic as to the CRP mechanism, which may be provided by PUFs, one-time pads, etc., but are preferably provided according to the methods set forth above with respect to FIG. 1 or 2. That is to say, the CRP mechanism is derived from the encrypted files themselves (e.g., the file or its abstract), which are processed according to the methods described above, segmented into addressable responses, and then challenged with challenges.

It should be understood that, unless explicitly stated or otherwise required, the features disclosed in embodiments explicitly described herein and elsewhere in this disclosure may be used in any suitable combinations. Other embodiments and uses of the above inventions will be apparent to those having ordinary skill in the art upon consideration of the specification and practice of the invention disclosed herein. It should be understood that features listed and described in one embodiment may be used in other embodiments unless specifically stated otherwise. The specification and examples given should be considered exemplary only, and it is contemplated that the appended claims will cover any other such embodiments or modifications as fall within the true scope of the invention.

The invention claimed is:

1. A method of generating a decryptable encrypted file M* attesting to the authenticity of a file F on a computing device, comprising:
receiving a digital file C;
generating a nonce ω;
generating a random stream S;
hashing C with ω and applying the resulting hash to an extended output function resulting in C*;
organizing C* into d addressable segments having addresses 1 to d;
deriving a set of N challenges from S, where each challenge encodes an address within the range of 1 to d;
extracting from C* a sequential, addressable set of N responses corresponding to the addresses in C* encoded in the set of N challenges;
using the N responses as or to derive an encryption key K;
receiving a message M attesting to the authenticity of F, and using K to encrypt M resulting in M*.

2. The method of claim 1, wherein deriving a set of N challenges from S comprises hashing S and supplying the resulting hash to an extended output function resulting in a bitstream having a sufficient bit length such that it may be segmented into segments of sufficient bitlength to identify every address 1 to d.

3. The method of claim 1, wherein hashing C with ω comprises concatenating C and ω and hashing the resulting bitstream.

4. The method of claim 1, wherein the hashing step is performed using one of SHA-1, SHA-2 or SHA-3.

5. The method of claim 1, wherein the extended output function is SHAKE.

6. The method of claim 1, wherein the digital file C is an encrypted version of F.

7. The method of claim 1, wherein each of the N responses has a length of P and comprises the value at a position in C* indicated by a corresponding challenge and a succeeding series of P-1 bits.

8. The method of claim 1, wherein using the N responses as or to derive an encryption key K comprises concatenating the N responses resulting in the encryption key K.

9. The method of claim 1, further comprising storing the nonce ω and distributing C, the seed S, and M* to a second computing device.

10. The method of claim 9, further comprising deleting K.

11. A method of generating a decryptable encrypted file M* attesting to the authenticity of a file F on a computing device, comprising:
receiving a digital file C;
generating a nonce ω;
generating a random stream S;
hashing C with ω and applying the resulting hash to an extended output function resulting in C*;
organizing C* into d addressable segments having addresses 1 to d;
deriving a set of N challenges from S, where each challenge encodes an address within the range of 1 to d;
extracting from C* a sequential, addressable set of N responses corresponding to the addresses in C* encoded in the set of N challenges;
generating an encryption key K;
receiving a message M attesting to the authenticity of F;
using K to encrypt M resulting in M*;
identifying those responses in the addressable set of N responses located at addresses having the same sequential positions of a first binary symbol in K, resulting in an identified subset of responses; and
storing the identified subset of responses and delete K.

12. The method of claim 11, wherein deriving a set of N challenges from S comprises hashing S and supplying the resulting hash to an extended output function resulting in a bitstream having a sufficient bit length such that it may be segmented into segments of sufficient bitlength to identify every address 1 to d.

13. The method of claim 11, wherein hashing C with ω comprises concatenating C and ω and hashing the resulting bitstream.

14. The method of claim 11, wherein the hashing step is performed using one of SHA-1, SHA-2 or SHA-3.

15. The method of claim 11, wherein the extended output function is SHAKE.

16. The method of claim 11, wherein the digital file C is an encrypted version of F.

17. The method of claim 1, wherein each of the N responses has a length of P and comprises the value at a position in C* indicated by a corresponding challenge and a succeeding series of P-1 bits.

18. The method of claim 1, further comprising storing the nonce ω and distributing C, the seed S, the subset of responses and M* to a second computing device.

19. A method of decrypting an encrypted authenticity certificate M* attesting to the authenticity of a file F that has been encrypted as ciphertext C, comprising:
receiving C, a nonce ω and a random stream S;
hashing C with ω and applying the resulting hash to an extended output function resulting in C*;
organizing C* into d addressable segments having addresses 1 to d;
deriving a set of N challenges from S, where each challenge encodes an address within the range of 1 to d;
extracting from C* a sequential, addressable set of N responses corresponding to the addresses in C* encoded in the set of N challenges;
using the N responses as or to derive an encryption key K; and
decrypting M* with K.
